(19) United States
(12) Patent Application Publication
(10) Pub. No.: US 2003/0227475 A1
(43) Pub. Date: Dec. 11, 2003

(54) Apparatus and method for blocking television commercials and delivering micro-programming content

(75) Inventors: Craig William Fellenstein, Brookfield, CT (US); Rick Allen Hamilton II, Charlottesville, VA (US)

Correspondence Address: Rudolf O. Siegesmund, Suite 2000, 4627 N. Central Expressway, Dallas, TX, 75205-4017, US

(73) Assignee: International Business Machines Corporation, Armonk, NY

(21) Appl. No.: 10/165,296

(22) Filed: Jun. 6, 2002

(51) Int. Cl. G09G 5/00

(52) U.S. Cl. 345/720; 345/747

(57) ABSTRACT

An apparatus and method is disclosed for blocking specific television commercials from the viewer's television based upon the characteristics of the television commercial and replacing the commercial with a micro-programming segment prepared by an alternate viewing provider. A logical unit and a commercial blocking program in the logical unit allow alternative viewing options so that the user may choose micro-programming options to replace the unwanted communication.

The commercial blocking program recognizes a unique digital identifying tag that distinguishes a particular commercial from all other commercials. Alternatively, the commercial blocking program identifies a commercial by a “component signature” or an “overall digital signature.” Upon viewing an unwanted commercial, the user indicates that he wants to block the commercial through one of a variety of input methods. The commercial blocking program then prevents the commercial from being displayed on the user's television and causes alternative programming to be displayed instead. The user may configure the alternative programming via the alternative programming logic and choose to display micro-programming segments in place of the blocked commercial. The micro-programming segments are designed to provide a complete informational exchange or entertainment package in the time segment. The alternate viewing provider may provide the micro-programming by subscription service, or by non-subscription service where the micro-programming contains non-intrusive advertising.

### RELATED APPLICATIONS

This application is related to AUS920020014US1, “Apparatus and Method for Blocking Television Commercials and Displaying Alternative Programming.”

### FIELD OF THE INVENTION

The present invention relates to an apparatus and method for blocking undesired television commercials and displaying micro-programming in place of the blocked commercials.

### BACKGROUND OF THE INVENTION

Debates today rage about both the delivery and funding of informational content in all of its forms. On the Internet, many content providers are moving away from their advertisement-based business models and moving towards subscription-based business models. Despite rapid advances in technology, the delivery mechanisms and methods of generating revenue for content delivered through television broadcasts have been relatively stagnant, when compared to the delivery mechanisms and methods of generating revenue for the Internet and web delivery systems. In television broadcasts, advertisers still attempt to reach users using the same techniques that they have used for decades which are the thirty and sixty second commercials interspaced throughout specific television programs. In addition to technology, the viewer is becoming increasingly sophisticated and is demanding that every second of their time, whether engaged in work or leisure pursuits, be well spent. For the vast majority of television viewers, time engaged in viewing undesired advertisements is not considered time well spent. Therefore, a need exists for an apparatus and method of preventing a television viewer from viewing unwanted commercials.

Additionally, television viewers generally do not prefer to have periods of interrupted programming or “dead air” when they are viewing a program. It would be preferable if the blocked commercial could be replaced with user-defined alternative programming. Therefore, a need exists for an apparatus and method for replacing a blocked commercial with alternative programming which is more acceptable to the television viewer.

Furthermore, television viewers may want to play a more active role in determining what type of programming will replace the commercials they have chosen to block. Television viewers who choose to block certain commercials may want to selectively determine alternative programming which will replace the blocked commercial. The alternative programming may differ depending on the time of day or the particular channel which is currently being viewed. Therefore, a need exists for an apparatus and method which will allow television viewers to define the alternative programming content.

Television viewers may want to view a program that they may have missed instead of the commercial. In other words, it may be preferable to replace an unwanted commercial with television programming from another time on another television channel. Therefore, a need exists for an apparatus and method for buffering desired programming and displaying the desired programming in the time slot where the blocked commercial previously resided.

The time slots made available by a blocked commercial are short. Therefore, a need exists for specially designed alternative television programming in lengths designed to fit into commercial time slots. A further need exists for micro-programming that can be buffered for access as desired.

### SUMMARY OF THE INVENTION

The present invention, which meets the needs stated above, is an apparatus and method for blocking specific television commercials from the viewer's television based upon the characteristics of the television commercial and replacing the commercial with a micro-programming segment prepared by an alternate viewing provider. A logical unit and a commercial blocking program in the logical unit allow alternative viewing options so that the user may choose micro-programming options to replace the unwanted communication.

The commercial blocking program recognizes a unique digital identifying tag that distinguishes a particular commercial from all other commercials. Alternatively, the commercial blocking program identifies a commercial by a “component signature” or an “overall digital signature.” Upon viewing an unwanted commercial, the user indicates that he wants to block the commercial through one of a variety of input methods. The commercial blocking program then prevents the commercial from being displayed on the user's television and causes alternative programming to be displayed instead. The user may configure the alternative programming via the alternative programming logic and choose to display micro-programming segments in place of the blocked commercial. The micro-programming segments are designed to provide a complete informational exchange or entertainment package in the time segment. The alternate viewing provider may provide the micro-programming by subscription service, or by non-subscription service where the micro-programming contains non-intrusive advertising.

### BRIEF DESCRIPTION OF THE DRAWINGS

FIG. 1 is an illustration of the invention interacting with a cable provider and a television.

FIG. 2A is a flowchart of the commercial blocking program.

FIG. 2B is a flowchart of the alternative programming logic.

FIG. 2C is a flowchart of the micro-programming option.

FIG. 3 is a depiction of the data processing system contained within the logical unit.

### DETAILED DESCRIPTION OF THE PREFERRED EMBODIMENT

As used herein, the term “alternate viewing provider” means an entity that offers micro-programming to a user for display in conjunction with a logical unit. The term micro-programming, as used herein, means one or more “alternate viewing packages” that each contain a complete information exchange or an entertainment package in a segment of time that is adapted to fit into the time available from one or more commercials blocked by a logical unit. For example, an alternate viewing package could contain news headlines, weather updates, sports updates, or very short live action or animated shorts that are designed to entertain the user in a crisp, concise segment. An alternate viewing package would normally be thirty or sixty seconds in length but could be designed for any length of time that a logical unit could make available. The term “multiplex” as used herein means the process of funneling several different streams of data over a common communications line. The term “cable provider” as used herein means a company which provides television service to multiple users and includes satellite television providers. The term “buffering” as used herein means a process of examining the closed captioning text or audio signal associated with television signals and configuring the examined signal such that it may be searched for specific keywords. As used herein, the term “alternate viewing” means content displayed in place of a blocked commercial and may include one or more of the following: (1) a brief message displayed to inform the viewer that alternative programming will be presented during the commercial interval; (2) an on-screen counter, showing how many seconds are left before the planned return to primary viewing and (3) directions to the tuner to go to a particular station. The directions to the tuner may be universal, by commercial, by originating station, by time of day, by definition of an elaborate viewing hierarchy, or to a micro-programming station or to buffered micro-programming. As used herein, the term “staggered time alternate viewing package” means an alternate viewing package broadcast on start times that are staggered for a number of seconds to coincide with the time slots of blocked commercials. For example, an alternate viewing package may start at the top and bottom of the minute on a given station, and at 15 and 45 seconds on another station. Accordingly, the station with the alternate viewing package start time closest to the start time of the blocked commercial would be chosen. As used herein, the term “time synchronized” means an alternate viewing package, delivered on demand in which the user joins the broadcast at the exact start point of the micro-program. As used herein, the term “buffered” means an alternate viewing package stored in the memory of a logical unit or at the cable service provider so that synchronization problems between the “switchover” point and the alternate programming delivery do not occur. In other words, when a request for alternative programming is made, the logical unit can draw from a buffered alternate viewing package so that the user does not risk joining the alternate viewing package in progress. As used herein, the term “universal” means using content from a particular station to replace all blocked commercials. As used herein, the term “by commercial” means using content from a particular station to replace the specifically identified commercial. As used herein, the term “by originating station” means using the original station to determine the alternative content which will replace all blocked commercials. As used herein, the term “by time of day” means using the time of day to determine which station to use as alternative content for all blocked commercials. As used herein, the term “elaborate viewing hierarchy” means a combination of a plurality of universal, by commercial, by originating station, or by time or day alternative viewing formats As used herein, the term “unique digital identifying tag” means a number sequence before the header and after the trailer of each commercial. The number sequence is assigned according to an industry standard that allows each commercial to be identified from every other commercial. As used herein, a “component signature” is a group of variables, based on a time component, an X video component, a Y video component, and an audio component, that is used to identify a commercial from all other commercials when a “unique digital identifying tag is not available. As used herein, the term “cumulative digital signature” means the aggregation of one or more selected characteristics of a data sequence to provide a unique number for identification of the complete data sequence.

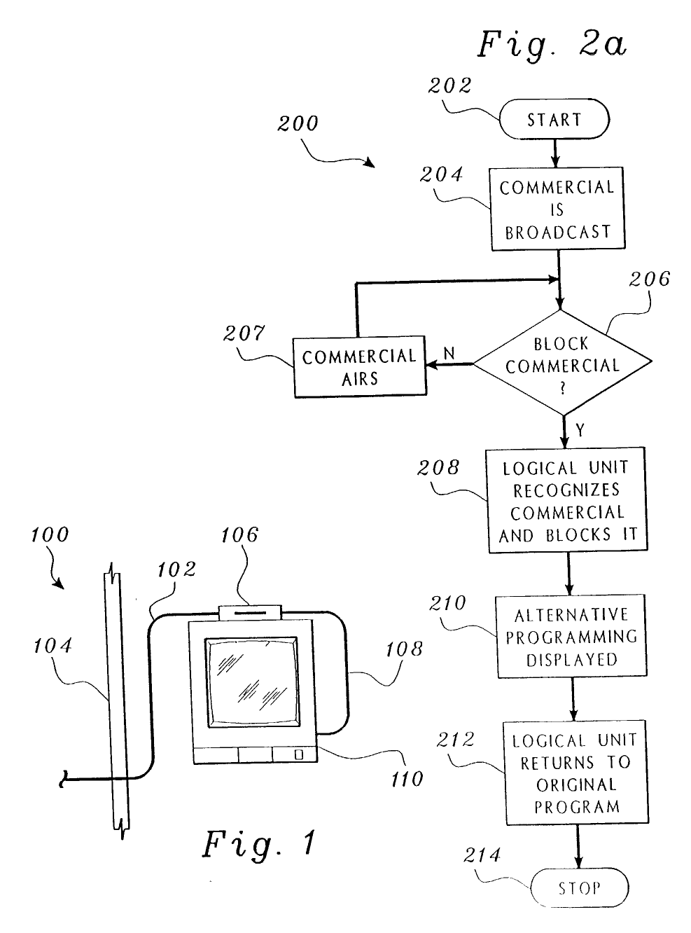

FIG. 1 is an illustration of the invention 100 interacting with a cable provider and a television set. The depiction of the cable provider is by way of illustration only and is not intended to limit the scope of the invention. Persons skilled in the art will recognize that the invention may be used with either a cable or wireless data transmission system. The cable provider (not shown) provides a television signal through a coaxial cable 102 that runs through the user's wall 104 and into the logical unit 106. Logical unit 106 analyzes the cable signal as described below and displays the information on television 110 via television connection 108. Logical unit 106 can optionally be combined with television 110. Alternatively, logical unit 106 may be placed at the same location as the cable provider such that it is unnecessary to have logical unit 106 at the user's location.

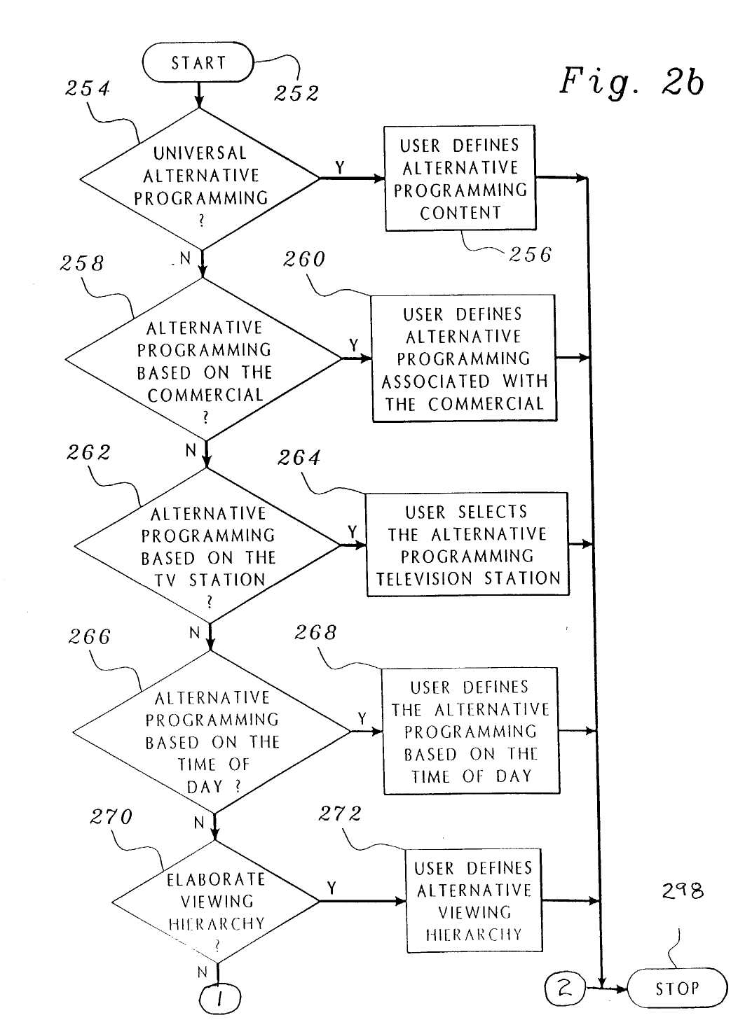

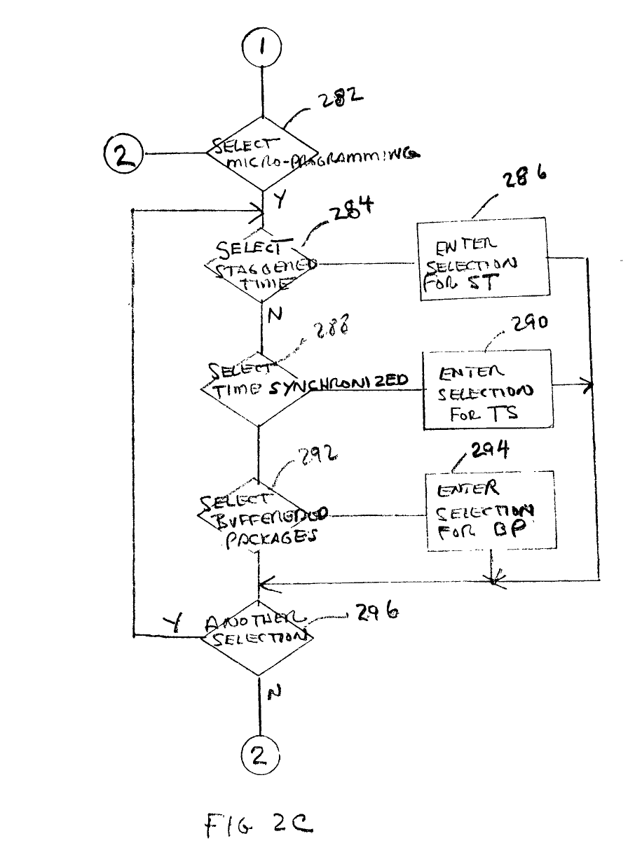

FIG. 2A is a flowchart of commercial blocking program 200 which operates inside logical unit 106. Commercial blocking program 200 starts (202) whenever multiplexed cable signals are broadcast (204). In the preferred embodiment, each commercial has a unique digital identifying tag, similar to a serial number, which identifies a particular commercial. Logical unit 106 recognizes a particular commercial based on the unique identifying tag.

In an alternate embodiment, logical unit 106 identifies commercials by a “component signature.” Multiplexed cable signals are defined by four components: a time component, an X video component, a Y video component, and an audio component. Every television program and/or commercial can be readily identified by these components. There is generally allowed some amount of time skew in the synchronization of the four components to identify the absolute beginning of a program or commercial. By taking the time skew into consideration, commercial blocking program 200 can identify a particular commercial. For example, a given pattern of video/audio signals occurring at a time “delta” (perhaps but not necessarily in the order of 500 microseconds) around the nominal beginning of an advertisement, may point back to a specified commercial.

Alternatively, logical unit 106 establishes an “overall digital signature” for a particular commercial. In this event, the signal need not be dissembled into its video/audio components as in the “component signature,” but rather, analysis of cumulative digital characteristics may be used to identify the commercial to be blocked. One or more characteristics of a data sequence is selected and aggregated to provide a unique number for identification purposes of the complete data sequence. The advantage of using cumulative digital characteristics is that all commercials could be blocked using this technique. In the case of commercials to be identified by an “overall digital signature,” the logical unit develops a library at the set-top of the “overall digital signature” of the blocked advertisements. For example, it may be assumed that some time interval, “Tₛₐₘₚₗₑ” is great enough to ascertain with accuracies approaching one hundred percent the identity of a given advertisement. “Tₛₐₘₚₗₑ” may be a sub-second or it may be multi-second, depending on the processing power behind the logical unit and the uniqueness of the commercial. Once a commercial signal is detected to be identical to a blocked advertisement, then the logical unit takes the actions it has been programmed to implement.

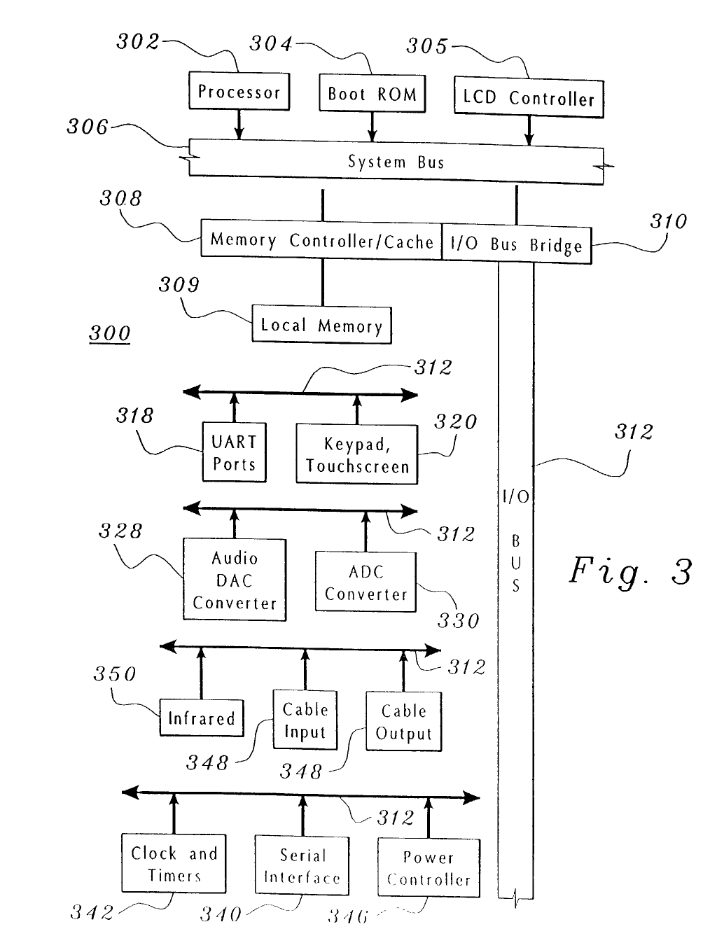

As a commercial airs, the user has the option of blocking the commercial (206) by means of commercial blocking program 200 located in the local memory 209 of logical unit 106 (See FIGS. 1 and 3). If the user chooses not to block the commercial, then commercial blocking program 200 allows the commercial to air (207) and returns to step 206. If at step 206 the user chooses to block the commercial, then the logical unit will block the commercial (208). In blocking the commercial, the logical unit prevents the specific commercial from displaying on the user's television and displays alternative content instead (210). After commercial blocking program 200 has displayed the alternative programming, the original programming of the original television channel is displayed (212) and commercial blocking program 200 ends (214).

There are many different types of alternative programming that commercial blocking program 200 can display on the user's television instead of the blocked commercial. In one embodiment, commercial blocking program 200 can display a blank screen for the duration of the blocked commercial. However, in the preferred embodiment, commercial blocking program 200 displays the programming according to alternative programming logic 250 in FIG. 2B. Alternative programming logic 250 starts (252) and queries the user if he or she would like to define the alternative programming as a universal television channel that will replace all blocked television commercials (254). A universal television channel is one which will display the contents of a specific television channel on the user's television whenever the blocked commercial airs. For example, whenever a blocked commercial airs, commercial blocking program 200 will cause the The Weather Channel to be displayed. A universal television channel may include Web TV or any programming variation that may be made available to the user of the television to which the logical unit is connected. If the user determines that they would like to select a universal alternative channel, then the user specifies which channel is the universal television channel (256) and alternative programming logic 250 ends (294). If at step 254 the user determines that he or she would not like to select a universal television channel, then alternative programming logic 250 queries the user if he or she would like to define the alternative programming based on the blocked commercial (258). Alternative programming based on the blocked commercial will display a particular television channel whenever a specific blocked commercial airs. For example, whenever commercial X airs, commercial blocking program 200 will cause The Weather Channel to be displayed. If the user determines that he or she would like to define the alternative programming based on the blocked commercial, then the user selects a specific television channel that will display whenever the specific television commercial airs (260) and alternative programming logic 250 ends (298). If the user determines at step 258 that he or she do not want to define the alternative programming based on the commercial, alternative programming logic 250 queries the user whether he or she would like to define alternative programming based on the television channel (262). Alternative programming based on the television channel will display television content based on a preferred television channel and a contingent television channel when the blocked commercial airs. For example, whenever a blocked commercial airs, The Weather Channel will be displayed, and in the event The Weather Channel is already being displayed, then CNN will be displayed. If the user determines that he or she would like to define the alternative programming based on the television channel, then the user defines the preferred and contingent television channels (264) and alternative programming logic 250 ends (298). Optionally, a contingent television channel may be selected by a Content Interrogation Program (CIP) that selects a particular television channel based upon selected search criteria. For example, the CIP may be set by the user to search for news alerts, weather alerts, or some other criteria presented to the user from a CIP menu. If at step 262 the user determines that he or she does not want to define alternative programming based on the television channel, then alternative programming logic 250 queries the user whether he or she would like to define alternative programming based on the time of day (266). Alternative programming based on the time of day displays a specific television channel depending on the time of the blocked commercial. For example, if the blocked commercial airs before noon, The Weather Channel will be displayed, and if the blocked commercial airs after noon, CNN will be displayed. If the user would like to define the alternative programming based on the time of day, then the user defines the alternative television channels and the time associated with each alternate channel (268) and alternative programming logic 250 ends (298). If at step 266 the user determines that he or she does not want to define the alternative programming based on the time of day, alternative programming logic 250 queries the user whether he or she would like to define alternative programming based on an elaborate viewing hierarchy (270).

An elaborate viewing hierarchy is a combination of the alternative programming determinations in steps 254, 258, 262, and 266. There are numerous possible combinations of the programming determinations that will create elaborate viewing hierarchies. For example, one possible elaborate viewing hierarchy would be “whenever a blocked commercial airs, display The Weather Channel; however, if there is also a blocked commercial on The Weather Channel, then go to CNN before noon and CNBC after noon.” The elaborate viewing hierarchy may offer the user the option to “mix and match” various combinations of blocked and unblocked signals. For example, the user may select a split screen option where the blocked commercial appears in a portion of the screen while alternate programming appears in the remaining portion of the screen. The user may select an option that will display alternative programming while also displaying the close captioned text of the blocked commercial. Further in the alternative, the user may elect to have more than one alternate programming option displayed. For example, the user may elect to have a split screen display CNN on one portion of the screen and the Weather Channel on the other portion of the screen. If the user would like to define an elaborate viewing hierarchy, then the user enters the appropriate information (i.e. time, channel, and commercial) to define the hierarchy (272) and alternative programming logic 250 ends (298). If at step 270 the user determines that he or she would not like to define an alternative viewing hierarchy, alternative programming logic 250 goes to step 282 (See FIG. 2C).

Next a determination is made as to whether the user wants to select micro-programming (282). If the user does not want to select micro-programming, alternate programming logic 250 ends (298). If at step 282 the user determines that he or she wants to select micro-programming, a determination is made as to whether staggered time alternate viewing packages are desired (284). If staggered time alternate viewing packages are desired, then the selection is entered (286) and alternate programming logic 250 goes to step 296. If staggered time alternate viewing packages are not selected, then a determination is made as to whether the user wants to select time synchronized alternate viewing packages (288). If the user desires to selected time synchronized alternate viewing packages, then the selection is entered (290) and alternate programming logic 250 goes to step 296. If the user does not select time synchronized alternate viewing packages, then a determination is made as to whether a buffered alternate viewing package is desired (292). If a buffered alternate viewing package is desired, then the selection is entered (294). If a buffered alternate viewing package is not desired, then a determination is made as to whether another selection is made (296). If another selection is to be made, alternate programming logic 250 goes to step 284. If another selection is not to be made, alternate programming logic 250 ends (298). A default option may also be available if the alternate viewing service provider plays continuously broadcast alternate viewing packages. In that case the default option would be that the television would move to the alternate viewing broadcast at the time of the blocked commercial and pick up the alternate viewing package playing at that time.

In an alternative embodiment of alternative programming logic 250, a negative determination at step 296 would send the user back to step 254 so that the options may be viewed again. Additionally, there are other types of alternative programming which may be displayed at step 210. Logical unit 106 can buffer the multiplexed cable signal. Such technology is known in the art. U.S. Pat. No. 5,481,296 issued on Jan. 2, 1996 discloses an “Apparatus and Method for Selectively Viewing Video Information.” The user can then enter search criteria and search program 200 will record the television signal based on the specific time, channel, and/or keywords. For example whenever “and now your local forecast” is found in the audio component of the cable signal for The Weather Channel, logical unit 106 can record the accompanying local forecast. Additionally, logical unit 106 can be set to record a specific show. For example, logical unit 106 could be set to record the 11 a.m. Sports Center on ESPN. In either case, the recorded programming can be displayed in place of the blocked commercial.

Many optional features can be displayed along with the alternative programming. For example, it may be beneficial to display a timer in the corner of the screen which shows the time remaining until the end of the blocked commercial. Additionally, the user may desire to have a brief description of which commercial is being blocked. Moreover, the user may wish to have a timer counting down the amount of time until the desired television content returns. Furthermore, the inventive concept contained herein can be utilized to block all commercials and display only desired programming. If the user desires to block all television commercials, then the logical unit develops a library of the unwanted commercials. The library of blocked commercials could be accessed by the user according to an Archive Interrogation Program (AIP) that would allow the library of blocked commercials to be searched by key words, phrases, date and time or other any other method that a person skilled in the art may use to search a library of stored data. Commercials designated as blocked by the user are added to the library and blocked in the future. Alternatively, the logical unit can buffer the entire multiplexed signal, delay the signal a pre-determined time (i.e. sixty seconds) and block out all television programming that is not greater than sixty seconds. This would block all thirty and sixty second television commercials. This implementation can also be orchestrated at the cable provider rather than the user's television or the logical unit. The user may have the option to block selected commercials permanently (without the recourse to unblock the commercial at a later time) while designating other commercials as non-permanently blocked commercials (with the recourse to unblock the commercial at a later time). The user may have the option to block all previously blocked commercials (and to view new commercials) or to block all commercials. In addition, the user may be provided with the option to block, unblock and access the programming of the logical unit by means of voice commands or audible signals such as clapping.

FIG. 3 is a depiction of the data processing system 300 contained within housing of logical unit 106. Data processing system 300 comprises processor 302, boot ram 304, and LCD controller 305 coupled to system bus 306. Also connected to system bus 306 is memory controller/cache 308, which provides an interface to local memory 309. I/O bus bridge 310 is connected to system bus 306 and provides an interface to I/O bus 312. Memory controller /cache 308 and I/O bus bridge 310 may be integrated as depicted. Peripheral components are connected via I/O bus 312. Typical peripheral components include Universal Asynchronous Receiver Transmitter (UART) 318, a keypad or touch screen 320, digital-to-analog converters 328, analog-to-digital converters 330, serial interface controller 340, clocks and timers 342, cable output to the television 344, power controller 346, cable input from the cable provider 348, and infrared ports 350. Those skilled in the art will appreciate the depiction of data processing system 300 in FIG. 3 is exemplary and is not intended as an architectural limitation of the present invention. Data processing system 300 may be a separate single controller.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. A method for displaying alternate viewing packages in place of television commercials comprising:
using a logical unit, selecting a micro-programming option;
receiving a first television signal;
recognizing said first television signal in the logical unit;
blocking said first television signal by the logical unit; and
displaying a second signal wherein said signal is an alternate viewing package.

2. The method of claim 1 wherein said first television signal is a commercial.

3. The method of claim 1 wherein said first television signal is recognized by the time, audio, and video components of said first television signal.

4. The method of claim 1 wherein said first television signal is recognized by an identifying tag.

5. The method of claim 1 further comprising:
buffering the alternate viewing package.

6. The method of claim 1 further comprising:
selecting a staggered time option.

7. The method of claim 1 further comprising:
selecting a time synchronized option.

8. The method of claim 1 further comprising:
selecting a buffered package option.

9. A method of determining alternative programming displayed during a blocked television commercial comprising:
displaying a micro-programming option to a user;
receiving a micro-programming selection from said user;
blocking a first television signal; and
responsive to user selection of the micro-programming option, displaying an alternate viewing package based on the user selection.

10. The method of claim 9 further comprising:
buffering the alternate viewing package.

11. The method of claim 9 further comprising:
displaying the alternate viewing package in staggered time.

12. The method of claim 9 further comprising:
displaying the alternate viewing package in synchronization.

13. The method of claim 9 further comprising:
displaying a buffered alternative viewing package.

14. A programmable apparatus for displaying micro-programming in place of blocked television programs comprising:
programmable hardware;
software;
said hardware being directed by said software to:
receive a first television signal;
recognize said first television signal;
block said first television signal; and
display a second television signal;
wherein said second television signal is an alternate viewing package.

15. The apparatus of claim 14 wherein said first television signal is a commercial.

16. The apparatus of claim 14 wherein said software further directs said hardware to:
buffer the alternate viewing package; and
store the alternate viewing package in a memory.

17. The apparatus of claim 16 wherein said second television signal is defined as the contents of said memory.

18. The apparatus of claim 14 wherein the second television signal is synchronized.

19. The apparatus of claim 14 wherein the second television signal is buffered.

20 The apparatus of claim 14 wherein the second television signal is staggered.

21. A programmable apparatus for displaying micro-programming in place of a blocked television commercial comprising:
programmable hardware;
software;
said hardware being directed by said software to:
display a plurality of alternative programming options to a user;
receive input from said user;
block a first television signal; and
responsive to a selection by the user of a micro-programming option,
display a second television signal based on said selection.

22. The apparatus of claim 21 wherein said software further directs said hardware to:
buffer a second television signal;
record said second television signal in a memory.

23. The apparatus of claim 21 wherein said second television signal is defined as the contents of said memory.

24. The apparatus of claim 21 wherein the second television signal is synchronized.

25. The apparatus of claim 21 wherein the second television signal is buffered.

26 The apparatus of claim 21 wherein the second television signal is staggered.
